(19) United States
(12) Patent Application Publication
(10) Pub. No.: US 2002/0198990 A1
(43) Pub. Date: Dec. 26, 2002

(54) System and method for remotely monitoring and controlling devices

(76) Inventors: William T. Bradfield, North Wales, PA (US); John Lavender, Berwyn, PA (US)

Correspondence Address: DANN DORFMAN HERRELL & SKILLMAN, SUITE 720, 1601 MARKET STREET, PHILADELPHIA, PA, 19103-2307, US

(21) Appl. No.: 10/179,233

(22) Filed: Jun. 25, 2002

Related U.S. Application Data
(60) Provisional application No. 60/300,663, filed on Jun. 25, 2001.

(51) Int. Cl. G06F 15/173

(52) U.S. Cl. 709/224

(57) ABSTRACT

Disclosed is a system for use in remotely monitoring and controlling devices. The system provides bi-directional control and monitoring functions to allow devices that cannot currently be managed remotely to be monitored and controlled in near real-time from a remote location. Sensors embedded in or on the device, asset or process being monitored record operating and device status data. These sensors transmit device conditions to a communications device (referred to herein as a “communicator”) through a variety of industry-standard device control protocols. The communicator then evaluates the data and, if necessary, converts the data to a compressed protocol for transmission to a centralized gateway server. The compressed protocol has a structure tailored to the needs of monitoring remote devices. At the centralized gateway server, the compressed protocol is converted to an industry-standard device management protocol. The data is then useable by any device management software using that industry standard device management protocol. Preferably, the system provides for the conversion of data streams in near real-time between an industry-standard device control protocol such as, for example, Modbus or BACNet, and the compressed protocol, as well as the conversion of data streams in near real-time between the compressed protocol and an industry-standard device management protocol such as, for example, SNMP (Simple Network Management Protocol). The remote devices that can be managed and/or controlled include but are not limited to HVAC (Heating, Ventilation and Air Conditioning) devices and other devices used in refrigeration applications (e.g., commercial refrigerators, freezers and refrigerated display cases). Therefore, in preferred embodiments, the system provides for bi-directional data conversion to allow devices not currently manageable by SNMP to be monitored and controlled in near, real-time.

### CROSS REFERENCE TO RELATED APPLICATION

Priority is claimed herein to U.S. Provisional Application No. 60/300,663, filed Jun. 25, 2001, which is fully incorporated by reference herein, including appendices filed therewith.

### FIELD OF THE INVENTION

The present invention relates to systems and methods for remotely managing and controlling devices and more particularly to systems and methods for remotely managing and controlling devices that have, historically, not been remotely manageable or controllable.

### BACKGROUND OF THE INVENTION

There is an increasing need to manage and/or control devices that have historically been unmanageable and/or uncontrollable due to accessibility (e.g., they are in remote locations) or lack of local capability (e.g., they are “dumb” devices such as devices with no local computing power). This has not reduced the need to manage the devices, simply the ability to manage them. In fact, as the devices get more complex and the cost to operate and maintain the devices goes up, the need to manage the devices effectively goes up even faster. As a consequence, the market for “intelligent” devices, such as devices with local computing power, is growing rapidly. Unfortunately, there are few intelligent devices currently available and the standards for communicating device status to a centralized location for management are myriad.

The ability to manage remote, dumb devices has been available for many years. Unfortunately, the bulk of the systems operate with wired environments; that is, each device being managed has a wire that runs back to the central monitoring station. These systems are robust and time-tested and have been employed in areas where real-time management of assets is essential. The devices managed by the invention, however, do not need to be managed in real-time; there is no need for a permanent link. A transient link (e.g., a link which uses a wireless transport) is acceptable and may be preferable.

Fortunately, there are a number of device management systems that have been designed for use with transient links. However, the systems are dependent on the remote devices being intelligent enough to determine when to send relevant data about device status to the central device management system (e.g., when to create the transient link). Some of these systems use a standard protocol called Simple Network Management Protocol (SNMP) that allows for the management and control of intelligent devices. Historically, these systems have been used to manage networks of computer equipment like PCs, Routers and Servers. SNMP has been in general use since the mid-1980s to manage and control these types of devices and there are several major product offerings currently available (i.e., Unicenter™ (CA), Tivoli™ (IBM), Openview™ (HP)) to effect that purpose. As noted above though, these systems are not designed to handle dumb devices.

The final problem that this invention addresses concerns the amount of data that needs to be transmitted over the transient link. While SNMP is extremely robust and while it is capable of handling transient links, the message, or “trap” as it is called in the SNMP environment, can range in size from approximately 2,000 bytes to over 300,000 bytes of data. This volume of data puts a significant burden on wireless communications channels, which are designed to carry messages that range in size from just a few bytes up to 2,000 bytes.

While the number of intelligent devices is on the increase, there are a substantial number of devices already installed to which intelligence cannot be added. The intelligence can only be added through a separate device that would act as a proxy agent. Unfortunately, while intelligent, to solve the accessibility problem, these proxy devices need to use some form of wireless communications to transmit data regarding the machine state (e.g., On/Off) or receive data related to a desire to change the state (e.g., from On to Off or vice-versa).

The present invention addresses these and other problems.

### BRIEF DESCRIPTION OF THE DRAWINGS

The foregoing Summary, as well as the following Detailed Description, will be best understood in conjunction with the appended drawings in which:

FIG. 1 is a block functional diagram of a monitoring and control system in accordance with the present invention; and

FIG. 2 is a logical flow diagram of a message transmission and receiving method carried out in the system of FIG. 1.

### DETAILED DESCRIPTION OF THE INVENTION

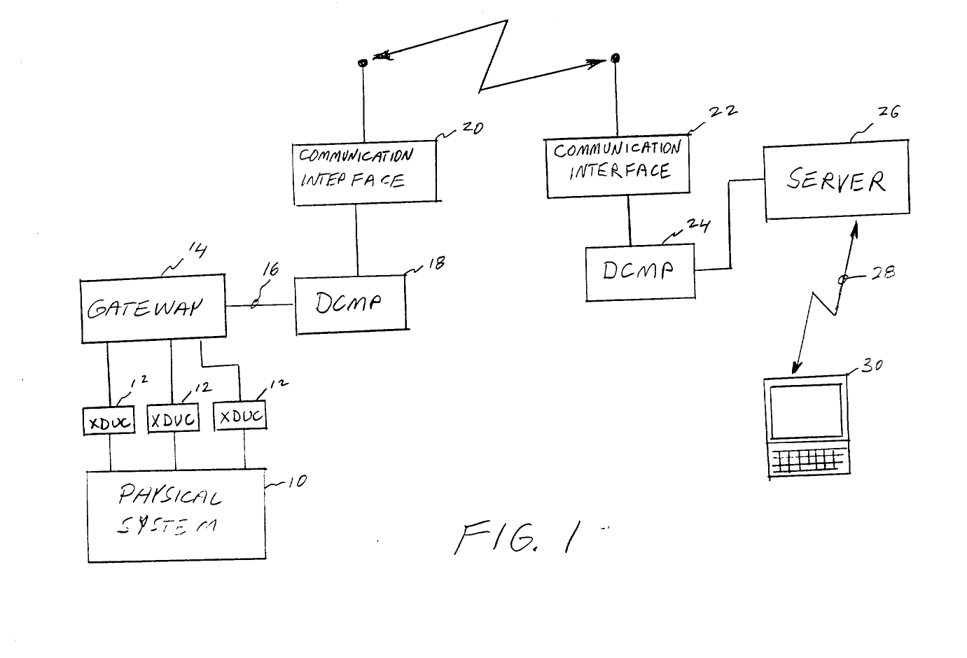

The present invention provides a system that enables the management and control of remote devices, whether intelligent or not, using standards-based device management software and wireless transports in conjunction with defined message formats. Features of the invention shall now be described with reference to FIG. 1, wherein the physical system to be controlled is designated as 10, and examples of which shall be described below.

The physical system is equipped with one or more transducers 12, each being capable of reading the current state of the remote device (e.g., whether the device is On or Off) and/or changing the state of the remote device (e.g., if the device is On, turn it Off). In some embodiments, the particular remote device that is to be managed and/or controlled includes one or more transducers that can be used with the system, and in such embodiments, the system can use those transducers to effect the management and control capability. Transducers suitable for use with the system include but are not limited to, temperature probes, thermostats, contact switches (e.g., on-off or open-closed indicators), humidity indicators or light level indicators.

In some embodiments, the transducers may comprise a standard control system for the physical system 10. For example industrial equipment such as heating, ventilating and air conditioning equipment controllers are known which utilize native industrial equipment control and communication protocols such as MODBUS or BACnet for effecting monitoring and control operations in such systems.

The transducers, whether part of a standard control system or a custom configuration of transducers for controlling the physical system, are connected with a gateway controller 14. The gateway controller 14 includes operating logic for operating transducers which are operably connected to the physical system such as relays, switches, or other controls for effecting control of aspects of the physical system. The gateway controller may also comprise analog-to-digital converters for converting voltages representative of physical values, e.g. temperature, pressure, etc., into digital signals. The gateway controller 14 may also comprise a standard industrial control interface for physical systems for which such control interfaces are known. The gateway controller 14 periodically collects information from the transducers 12 indicating the present operating condition of the physical system 10. The gateway controller preferably comprises a memory for maintaining present measurements or status indications of the transducers, for example whether a switch is on or off. Additionally, for operably-connected transducers, the gateway controller 14 maintains the present operating condition of the physical system 10.

The gateway controller 14 is configured to transmit and to receive messages along a communication link 16. The communication link 16 may implement a standard control protocol, such as SNMP, to transmit information about the present condition of the transducers 12, or to receive operating commands to effect control of the physical system 10 via one of the transducers 12. To reduce the number of status messages sent from the gateway controller 14 along communication link 16, the gateway controller 14 may be configured to transmit a message pertaining to a transducer only upon detection of a change of status of the transducer, or when the measurement made by the transducer has changed beyond a predetermined threshold amount.

The gateway controller 14 is connected via a communication link to a device control management protocol (DCMP) interface 18. The DCMP interface 18 collects messages from the gateway controller and translates messages from the gateway controller 14 into a compressed format sufficient to contain an identification of the transducer, and the value representing the condition of the transducer which is to be communicated. The DCMP interface 18 may, for example, translate SNMP messages from the gateway controller 14 into a truncated message format suitable for transmission via a bi-directional pager network.

The DCMP interface 18 is further connected with a communication interface 20 for transmitting and for receiving messages to and from the DCMP interface 18 to a remote location. In a preferred embodiment, the communication interface is a transceiver based on the on the Motorola “CREATEALINK” 2XT device, which is a bi-directional communication interface which utilizes the 900 Mhz Narrowband Personal Communication Services paging network to send and to receive messages. In other embodiments, the communication interface 20 may include a dial-up modem connected to the telephone network; a cellular modem, such as a GSM modem; or a LAN or WAN connection, such as a TCP/IP connection over various transport media. In embodiments utilizing a wireless network, the communication interface 20 can operated according to any suitable wireless communication protocol, including but not limited to the types of wireless communication protocols discussed in the appendices, such as, for example, Wireless Communications Transfer Protocol (WCTP). WCTP does not require that the wireless device be capable of responding. For example, a one-way numeric pager would be equally as accessible as any device capable of bi-directional messaging. Although introduced through the paging industry, WCTP is directly applicable for messaging to and from most other wireless technologies including PCS, GSM, and cellular.

At a remote location from the physical system 10, messages from the communication interface 20 are received by a compatibly configured communication interface 22. The communication interface 22 is preferably bi-directional for receiving messages from the interface 20, and for transmitting messages to the interface 20, as shall be described further below. The communication interface 22 is connected with a DCMP interface 24 for translating messages to and from the interface 22 into a standard protocol, such as SNMP or other suitable messaging protocol.

The DCMP interface 24 is connected with one or more centralized servers 26 that are in communication with one or more physical systems via network communication links such as have been described. For each physical system, the server 26 provides a management environment which may be adapted to the specific requirements of the physical system. Examples of such management environments shall be described below. Servers that are suitable for use with the invention include, for example, any Intel- or RISC-based server running a commercially available operating system such as, for example, HP-UX™, Windows 2000™ Server or Sun OS™. It should be understood that the functionality of a particular centralized server can in some embodiments be distributed to one or more computers and/or devices, rather than being performed on a single computer or device.

For each physical system served by the centralized server, the management environment preferably operates according to a set of rules. Examples of such rules include, on a unit attached to a rooftop air conditioning unit with sensors at multiple points: (a) if the air pressure measured at intake is more than 20% higher than the air pressure that is being sent to the building, then the air filter needs to be replaced; therefore, send a low-level alarm; (b) if the compressor is shut down for more than 4 hours AND it is between the hours of 8:00 am and 6:00 pm AND the outside temperature is greater than 80 degrees Fahrenheit, then the compressor has failed; therefore send a high-level alarm; (c) if the oil pressure in the compressor exceeds a maximum safe value (e.g., determined by the manufacturer), then turn off the compressor AND send an urgent alarm; and/or (d) if the oil pressure in the compressor is above a specified value but below a higher specified value, then request additional data an appropriate amount of time later to make sure that the value data is not an anomaly. When information received at the centralized server 26, when combined with a rule, indicates that action is to be taken, the centralized server 26 generates a control message. The control message is then sent via the DCMP 24 and interface 22 to the remote communication network, and is received at communication interface 20. The message is then translated by DCMP interface 18 and sent to the gateway controller 14 in order to effect operation of the appropriate transducer 12. Preferably, once the change is completed, the communicator sends back a response to the gateway server that the requested change has been made. The response can be additional sensor data, and/or a specialized response.

Further examples of such management environment rules include, on a unit attached to a refrigerator: (a) if the temperature inside the refrigerator exceeds the thermostat setting for more than 15 minutes AND the defrost cycle timer is off, then send a low-level alarm; (b) if the temperature inside the refrigerator exceeds the thermostat setting for more than 30 minutes AND the defrost cycle timer is off, then send a moderate-level alarm; and/or (c) if the door is open for more than 2 minutes, send a low-level alarm. It should be understood that additional or alternative rules can be used with the invention, and can be tailored as necessary according to the particular asset or device being managed or controlled. It should also be understood that alarms can be used as discussed, but other types of indication data can be sent alternatively or additionally.

Accordingly, as discussed in greater detail in the appendices, the system effects similar functionality with one or more sensors that monitor one or more characteristics of one or more remote devices, passing sensor data from the sensors to each device management environment via one or more communicators, and passing instructions, as necessary, back to the sensors via the one or more communicators to achieve remote management and control of the remote devices. It should be understood that in some embodiments, the system provides for the management and/or control of a plurality of remote devices by a plurality of gateway servers that are in communication with one another. It should also be understood that other device management and network management protocols can be used with the invention, and the invention should be understood as limited to the protocols discussed or specifically referenced herein.

In addition to the operation of automated rules for each physical system, the corresponding management environment implemented by the server 26 may provide one or more further communication links, such as link 28, to allow monitoring or control of the physical system by a user via a computer 30. For example, the management environment implement on the server 26 may provide a hypertext transport protocol (HTTP) server adapted to communicate information to the computer 30, wherein the link 28 is an HTTP connection. Such a server, integrated with the management environment, may provide a tabular, graphical, or schematic view of measurements and operating conditions associated with the physical system 10, as indicated by the present condition of the transducers monitored by the gateway controller 14 and stored at the server 26. The management environment pertaining to each physical system 10 may store historical data collected from the system in order to provide tabular or graphical views of the data in order to monitor system performance or to verify regulatory compliance (as in, for example, food or dairy product processing operations).

Further communication links by which the server 26 may communicate information to a user may include a simple mail transport protocol (SMTP) server, by which a user may be notified by email when a predetermined condition, as defined by a rule of the management environment has occurred. Such rules for communicating with a user may include emergency conditions by which a user is to be notified immediately, and such information may be delivered by email to a paging service, or by a modem or other telecommunication interface to deliver a message to a user, such as by a voice-response telephone interface, a bi-directional pager, personal digital assistant or cellular telephone having messaging capability. The user may then respond by issuing a message to the server 26 to effect operation of one of the transducers of the physical system.

For example, in one embodiment, a lamps along a highway are desired to be monitored for proper operation, and to reduce service mileage spent inspecting the lamps for replacement. Each of the lamps (constituting the physical system) provided with a transducer in the form of a light level detector, and groups of lamps were aggregated to connect with one gateway controller 14. The server 26 receives messages indicating illumination of the lamps at night, and subsequently receives failure of a transducer to detect proper illumination at night. The server 26 implements an HTTP server which provides a map of the highway system graphically depicting operation of the lamps. Upon failure of a lamp, in accordance with a rule of the management environment for the system, the server dispatches a message (e.g. via an email message to a pager network) to a service person to replace the map.

In other embodiments, the system can be used for the monitoring and protection of valuable assets which are often unattended, such as yachts. A yacht is outfitted with transducers to indicate, for example, the presence of water, the opening of cabin doors, and operation of bilge pumps. These transducers are connected with a gateway controller aboard the yacht, which is further connected with a DCMP interface and a communication interface. The server is provided with a management environment for the yacht monitoring system which graphically depicts the transducers aboard the yacht and the present operating condition of the transducers. The server may further be configured to send an alert to the owner of the yacht, as described by the mechanisms above, in order to notify the owner of a predetermined alarm condition indicating failure of a bilge pump or unauthorized entry onto the yacht.

In embodiments wherein the server is configured to provide a management environment including an HTTP server, interactive controls may be presented to the remote user for effecting manual operation of the physical system. For example, the HTTP server may provide suitable control elements of an interactive web page presented to the user, which are interpreted by appropriate scripts operated at the server in response to user input to the web page. The user inputs are then translated by the server into appropriate command messages to be issued to the gateway controller 14 associated with the physical system 10.

The server 26 may further be configured to provide accessible logs of historical data retrieved from the transducers. In the dairy industry, for example, the quality of milk provided from a dairy is dependent in part on the cooling rate of the milk tank which collects milk from a milking machine. A dairy operation can be remotely monitored by providing transducers to report operation of a milking machine, operation of the cooling apparatus associated with the collecting tank, and of the tank temperature. In this manner, proper operation of the milking apparatus and of the cooling and storage temperature of milk in the tank can be monitored and verified, and records from each batch of milk obtained from the tank can be associated with delivery of the milk to a distributor.

In embodiments where wireless transport of information is conducted via the Wireless Communication Transfer Protocol (WCTP), or by equivalent alphanumeric protocols employing wireless bi-directional paging systems, it is advantageous to provide a system for verification that commands have been received and/or executed at the location of the physical system, in order to prevent divergence between the state of the physical system, and the model of that state maintained at the server. Additionally, because delivery of pager messages is subject to variable delay, it is desirable to provide a mechanism whereby the server is apprised of the time at which desired action has been taken at the gateway controller. The present invention includes a system by which messages sent via WCTP can be marked to indicate that the management environment is configured to receive verification of receipt and/or execution of messages sent to the gateway controller 14.

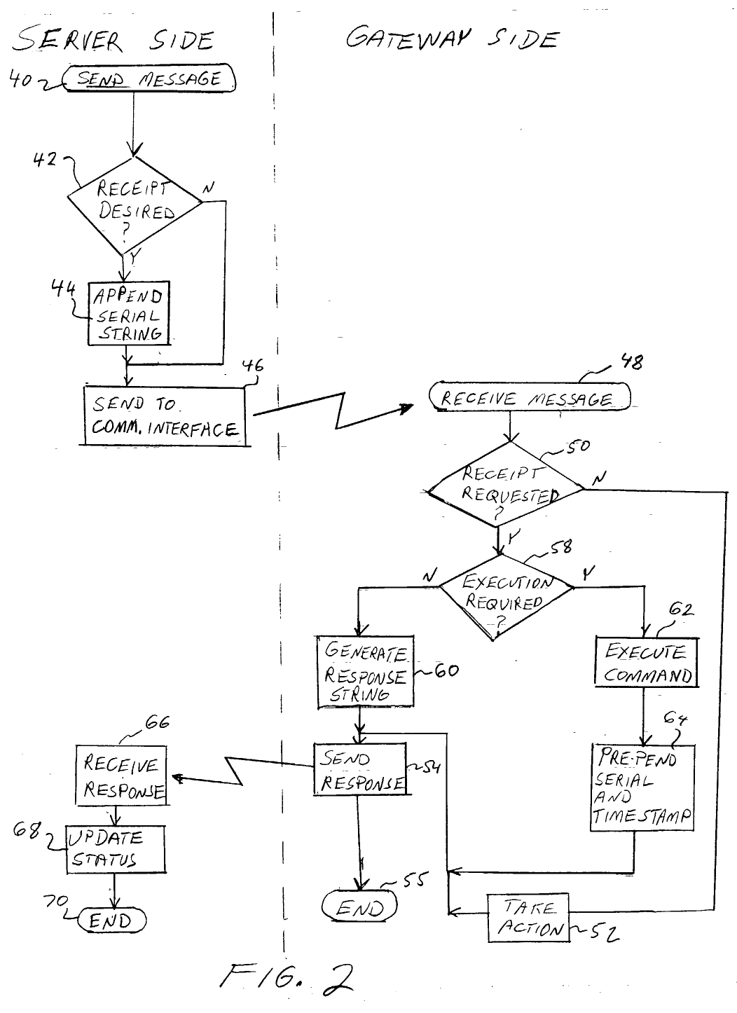

Referring now to FIG. 2, there is shown a method by which the server 26 and the gateway controller 14 may optionally confirm the receipt and execution of individual messages sent from the server 26 to the gateway controller 14. Beginning at step 40, the management environment of the server 26, whether in response to a user command or a rule of the management interface, prepares to transmit a message to the gateway controller 14. Proceeding to step 42, it is determined whether a receipt is desired for the message. If, in step 42, no receipt is desired, then the server proceeds to step 46 and communicates the message to the communication interface—in this case a pager network transmitter.

If, in step 42, a receipt is desired, then the server proceeds to step 44 to append a unique serial string to the message to be transmitted. In the preferred embodiment, the serial string is identified by a delimiter character, and then an alphanumeric sequence of four characters, such as “[ssss”, where “[” is the delimiter character and “ssss” is a serial string sequence. Then, the server proceeds to step 46 to transmit the message with the appended serial sequence.

The message is received by the gateway controller 14 at step 48, which then proceeds to step 50 to determine whether the received message includes a delimiter and serial string indicating that a receipt is requested. If no receipt is requested, the gateway controller proceeds to step 52 in order to carry out a received command or to retrieve a requested parameter of the physical system. Then, the gateway controller proceeds to step 54 to transmit any requested parameter or other response, if any, to the server via the wireless pager network.

If, in step 50, the gateway controller determines that a receipt is requested, then the gateway controller proceeds to step 58. In step 58, the gateway controller determines whether the message requires retrieval of an operating parameter or execution of a command generating a response from the physical system. If, in step 58, no such parameter retrieval or command execution is required, then the gateway controller proceeds to step 60. In step 60, the gateway controller generates a receipt for the message consisting of a delimiter character, the received serial string, and a time and date stamp. For example, such a receipt may be of the form “[ssssYYMMDDHHmmSS”, where “[” is the delimiter character, “ssss” is the serial string received in the original message, and “YYMMDDHHmmSS” is the year, month, day, and time in serial format. Then, the gateway controller transmits the receipt string in step 54, and exits in step 55.

If, in step 58, the received message is of the type requiring confirmation of execution or retrieval of a parameter, then the gateway controller proceeds to step 62 wherein the command is executed, and any return value or requested parameter is retrieved. From step 62, the gateway controller proceeds to step 64, wherein a receipt of the form described above is pre-pended to the response message. From step 64, the response message, with the pre-pended receipt, is transmitted to the server, and the gateway controller exits in step 55.

In step 66, the server receives the response message transmitted from the gateway controller. If the response message includes a receipt of the form discussed above, then the server matches the serial number of the receipt with a corresponding one of a queue of transmitted messages which requested a receipt, confirming that the message was received and acted upon at the indicated time therein, and proceeds to step 68 to update the server's record of the physical status of the system. The server then exits at step 70. In this manner, the server may maintain records of the time and date pertaining to operations undertaken within the physical system, or the status of physical parameters within the system, independent of the variable time delay introduced by use of a pager network as a transport mechanism for messages between the server and the gateway controller.

The foregoing description is intended by way of example and not of limitation. It will be appreciated that the invention is adapted to numerous variations within the scope of the appended claims.

That which is claimed is:

1. A system for remotely managing a physical system, comprising:
a transducer connected with the device for detecting a state of the physical system and for producing a monitoring signal;
a controller connected to receive the monitoring signal from the transducer and to produce a first communication signal corresponding to the monitoring signal;
a first protocol interface for receiving the first communication signal and for converting the first communication signal into a second communication signal in a format compatible with a data transport format;
a first communication interface comprising a first intermittent data transceiver connected to receive the second communication signal and to transmit the second communication signal as an intermittent data signal in the data transport format;
a second communication interface comprising a second intermittent data transceiver at a remote location from the physical system and operable to receive the intermittent data signal;
a second protocol interface connected with the second communication interface and operative to convert the received intermittent data signal into a data communication signal compatible with a central server;
a central server connected to receive the data communication signal from the second protocol controller, the central server including:
a management environment having a set of rules associated with the physical system, for effecting responsive action to the state of the physical system; and
an HTTP server process for providing user information pertaining to the state of the physical system to a remote user via an HTTP connection.

2. The system of claim 1 wherein the data transport format is one of TCP/IP format, a digital cellular format, and a narrowband personal data communication format.

3. The system of claim 2 wherein the data transport format is a narrowband personal data communication format, and wherein the first and second communication transceivers comprise wireless transceivers.

4. The system of claim 3 wherein the central server is configured for transmitting an alarm message to a remote user in response to a predetermined condition established by the rules.

5. The system of claim 4 wherein the central server is configured to transmit the alarm message as one of an SMTP message or a pager message.

6. The system of claim 1 wherein the central server is further configured to produce control signals for effecting control of the physical system to the second communication interface; the second communication interface is configured to transmit said control signals to the first communication interface, and said controller is configured to effect operation of said control signals by operable connection with a transducer operably connected with the physical system.

7. The system of claim 1 wherein the HTTP server is configured to provide an interactive display by which a user may indicate action to be taken within the physical system, and wherein the server is configured for transmitting a control message from the second communication interface to the first communication interface, and wherein the second communication interface is operably connected to the controller to effect the selected action.

8. The system of claim 1, wherein the first controller is a process controller and wherein the first communication signal is a MODBUS signal.

9. The system of claim 1 wherein the first communication signal is an SNMP signal.

10. The system of claim 1 wherein the central server is configured to determine whether an applicable one of said set of rules requires action to be effected within the physical system, and wherein said server is further configured for generating and transmitting a control message from the second communication interface to the first communication interface, and wherein the second communication interface is operably connected to the controller to effect the selected action.

11. A system for remotely managing a physical system, comprising:
a transducer connected with the device for detecting a state of the physical system and for producing a monitoring signal;
a controller connected to receive the monitoring signal from the transducer and to produce a first communication signal corresponding to the monitoring signal;
a first bi-directional wireless pager interface connected with the controller for receiving and transmitting messages with a wireless pager network;
a second bi-directional wireless pager interface at a remote location from the controller for receiving and transmitting messages with the wireless pager network
a central server connected with the second bi-directional wireless pager interface;
the central server configured to execute a management environment having a set of rules associated with the physical system, and for issuing commands to the controller in accordance with said rules, via the second bi-directional wireless pager interface; and
the controller configured for responding to a command received from the central server for operating the first bi-directional wireless pager interface to send said communication signal to the central server.

12. The system of claim 11, wherein the server is configured to include in said commands, a character sequence identifying commands for which acknowledgment of receipt by the controller is desired; and wherein the controller is configured to respond to said character sequence by transmitting a receipt message containing said character sequence after such commands are received by the controller.

13. The system of claim 12 wherein said receipt message includes an indication of the times when such commands were received by the controller.

14. The system of claim 12 wherein the controller is configured to combine said receipt message with said first communication signal.

15. The system of claim 11, wherein said transducer includes a device operably connected with the physical system for effecting a change of state within the physical system, and responsively connected with said controller.

16. The system of claim 15, wherein the server is configured to issue said commands to the controller to effect operation of the transducer.

17. The system of claim 11, wherein the server is configured to maintain a database of the state of the physical system on the basis of messages received via the second bi-directional wireless pager interface, and wherein the server is further configured to execute an HTTP server configured to allow a remote user to retrieve information from the database via said HTTP server.

18. The system of claim 17, wherein the server is configured to provide said information via the HTTP server in the form of a graphical display corresponding to the physical system.
